(19) United States
(12) Patent Application Publication
(10) Pub. No.: US 2024/0097217 A1
(43) Pub. Date: Mar. 21, 2024

(54) Method for Charging and Discharging Lithium Secondary Battery

(71) Applicant: LG Energy Solution, Ltd., Seoul (KR)

(72) Inventors: Insang Hwang, Daejeon (KR); Yojin Kim, Daejeon (KR); Juryoun Kim, Daejeon (KR); Il Young Cho, Daejeon (KR)

(73) Assignee: LG Energy Solution, Ltd., Seoul (KR)

(21) Appl. No.: 18/367,808

(22) Filed: Sep. 13, 2023

(30) Foreign Application Priority Data
Sep. 16, 2022 (KR) 10-2022-0117478

(51) Int. Cl. H01M 10/44; H01M 4/505; H01M 10/0525

(52) U.S. Cl. CPC H01M 10/446; H01M 4/505; H01M 10/0525; H01M 10/448

(57) ABSTRACT

A method for charging and discharging a lithium secondary battery includes: a first step of preparing a lithium secondary battery including a positive electrode, a negative electrode and an electrolyte, with the positive electrode comprising lithium-rich manganese-based oxide having a manganese content of 50 mol % or more among all metals excluding lithium as a positive electrode active material; a second step of charging the lithium secondary battery from the lower limit voltage to the first upper limit voltage and discharging the lithium secondary battery from the first upper limit voltage to the lower limit voltage; and a third step of charging the lithium secondary battery from the lower limit voltage to the second upper limit voltage and discharging the lithium secondary battery from the second upper limit voltage to the lower limit voltage, wherein the second upper limit voltage is 0.05V to 0.20V higher than the first upper limit voltage, and the second step and the third step are alternately and repeatedly performed on the basis of a fixed number of times of cycles.

### TECHNICAL FIELD

### Cross Citation with Related Application(s)

This application claims the benefit of Korean Patent Application No. 10-2022-0117478 filed on Sep. 16, 2022 in the Korean Intellectual Property Office, the disclosures of which are hereby incorporated by reference in their entirety.

The present disclosure relates to a charging and discharging method that can improve the life of a lithium secondary battery including Mn-rich positive electrode materials.

### BACKGROUND

In recent years, as environmental issues have attracted much attention, the demand for the use of alternative energy or clean energy is increasing, and as part thereof, the fields that are being studied most actively are the fields of power generation and power storage using electrochemical reactions. A typical example of an electrochemical device that uses an electrochemical reaction as an energy source is a secondary battery, and the area of use thereof tends to be expanding more and more. With the increasing demand for electronic devices such as computers, mobile phones, and cameras, as well as electric vehicles and energy storage systems, much research has been conducted on lithium secondary batteries that exhibit high energy density and operating potential, long cycle life, and low self-discharge rate.

Lithium secondary battery is generally manufactured by a method which includes interposing a separation membrane between a positive electrode containing a positive electrode active material made of a transition metal oxide containing lithium and a negative electrode containing a negative electrode active material capable of storing lithium ions to form an electrode assembly, inserting the electrode assembly into a battery case, injecting an electrolyte that serves as a medium for transferring lithium ions and then sealing the case.

Charging and discharging are performed through a process in which lithium ions emitted from the positive electrode active material are intercalated into the negative electrode active material during charge and are deintercalated again during discharge. Research to improve the life of a lithium secondary battery is being conducted mainly in the direction of changing the battery design itself, such as the materials contained in the positive/negative electrodes and electrolyte, or the structure thereof.

### PRIOR ART LITERATURE

### Patent Literature

KR 2013-0031079 A

### DETAILED DESCRIPTION OF THE INVENTION

### Technical Problem

It is an object of the present disclosure to provide a method that improves the life characteristics of a lithium secondary battery containing a Mn-rich positive electrode material by adjusting charging/discharging conditions without substantially changing the design of a battery.

### Technical Solution

According to one embodiment of the present disclosure, there is provided a method for charging and discharging a lithium secondary battery, the method comprising:
a first step of preparing a lithium secondary battery including a positive electrode, a negative electrode and an electrolyte, with the positive electrode comprising lithium-rich manganese-based oxide having a manganese content of 50 mol % or more among all metals excluding lithium as a positive electrode active material;
a second step of charging the lithium secondary battery from the lower limit voltage to the first upper limit voltage and discharging the lithium secondary battery from the first upper limit voltage to the lower limit voltage; and
a third step of charging the lithium secondary battery from the lower limit voltage to the second upper limit voltage and discharging the lithium secondary battery from the second upper limit voltage to the lower limit voltage,
wherein the second upper limit voltage is 0.05V to 0.20V higher than the first upper limit voltage, and the second step and the third step are alternately and repeatedly performed on the basis of a fixed number of times of cycles.

### Advantageous Effects

According to the method for charging and discharging a lithium secondary battery of the present disclosure, high voltage cycles are included at every fixed cycle during driving, and the rock-salt phase (Li₂MnO₃) is further activated when driving at high voltage, which makes it possible to develop additional capacity, thereby improving the life of lithium secondary batteries. Specifically, in a lithium secondary battery containing a positive electrode active material rich in manganese, provided is a method capable of improving energy retention rate as the cycle progresses without changing materials and structure.

### BRIEF DESCRIPTION OF THE DRAWINGS

FIG. 1 is a graph showing the energy retention rate and the voltage drop degree depending on the number of times of charging and discharging in the charge and discharge process of Examples and Comparative Examples.

### DETAILED DESCRIPTION OF THE EMBODIMENTS

Now, a method for charging and discharging a lithium secondary battery according to an embodiment of the present disclosure will be described in more detail.

A Mn-rich positive electrode active material having a manganese content of 50 mol % or more among all metals excluding lithium, for example, a lithium-rich manganese-based oxide positive electrode active material, has the advantage that it not only has a higher energy density compared to currently commercially available lithium nickel cobalt manganese (NCM)-based active materials, but also can reduce the amount of expensive cobalt used, thereby reducing the manufacturing costs.

However, there is a drawback that the rate at which capacity and energy deteriorate as the cycle progresses is high, and thus, for commercialization of lithium secondary batteries using Mn-rich positive electrodes, it will definitely require improvements in this regard.

Therefore, the present inventors have found that in a lithium secondary battery to which a Mn-rich positive electrode is applied, the charge/discharge protocol was improved by a method to add a high voltage cycle at each fixed cycle period during battery driving, and the energy retention rate is significantly improved compared to a conventional charge/discharge protocol where the upper limit voltage is constant.

Specifically, the method for charging and discharging a lithium secondary battery according to an embodiment of the invention includes the following first to third steps.

First Stop

In one embodiment, a method for charging and discharging a lithium secondary battery includes a first step of preparing a lithium secondary battery including a positive electrode, a negative electrode and an electrolyte, with the positive electrode comprising lithium-rich manganese-based oxide having a manganese content of 50 mol % or more among all metals excluding lithium as a positive electrode active material.

According to one embodiment, the lithium-rich manganese-based oxide may be represented by Formula 1 below:

Liₐ[Mn_{1-b-c}Ni_{b}M_{c}]₂₋ₐO₂ [Formula 1]
wherein in Formula 1,
M is at least one selected from the group consisting of Co, Fe, Cr, V, Cu, Zn, Ti, Al, Mg, B, W, Ga, In, Ru, Nb, Sn, Sr and Zr,
a, b and c are the atomic fractions of independent elements, 1<a, 0≤b≤0.5, 0≤c≤0.5, 0<b+c≤0.5.

Specifically, the a is the molar ratio of Li in the lithium-rich manganese-based oxide, which may be 1<a, 1.1≤a≤1.5, or 1.1≤a≤1.3. When a satisfies the above range, high capacity can be achieved.

The b is the molar ratio of Ni in lithium-rich manganese-based oxide, which may be 0≤b≤0.5, 0.1≤b≤0.4 or 0.2≤b≤0.4.

The c is the molar ratio of the doping element M in the lithium-rich manganese-based oxide, which may be 0≤c≤0.5, 0≤c≤0.3 or 0≤c≤0.1. The doping element M may preferably be Co, and if the content of the doping element is too high, it may not only have a negative effect on the active material capacity, but also increase the oxygen-oxidation-reduction reaction, which may deepen generation of gas and deterioration of the positive electrode active material, thereby leading to a decrease in the life characteristics.

The 1-b-c is the molar ratio of Mn in the lithium-rich manganese-based oxide, which may be 0.50≤1-b-c<1.0, 0.50≤1-b-c≤0.80, or 0.50≤1-b-c≤0.70. When 1-b-c is less than 0.5, that is, when b+c is greater than 0.5, the proportion of the rock-salt phase becomes too small and thus, the effects of compensating the negative electrode irreversibility and improving the capacity are minimal.

In the case of lithium-rich manganese-based oxide containing excess lithium, along with 50 mol % or more of manganese among metals other than lithium, it has a structure in which layered phase (LiM′O₂) and rock-salt phase (Li₂MnO₃) are mixed, wherein the rock-salt phase is activated at a high voltage of 4.6V or more to generate excess ions. Therefore, if lithium-rich manganese-based oxide is used as the positive electrode active material, the activation process is performed at a high voltage of 4.6 V or more without using a separate compensation material or pre-lithiation process. As a result, excess lithium ions generated by activation of the rock-salt phase are intercalated into the negative electrode, thereby achieving a pre-lithiation effect in which the irreversible capacity of the negative electrode is compensated. However, all rock salt phases (Li₂MnO₃) are not activated during the activation process. When charge/discharge is performed under the charging/discharging conditions according to one embodiment, the rock-salt phase (Li₂MnO₃) that is not activated in the activation process can be activated during cycle driving, which can contribute to improving the capacity retention rate.

Thus, the charging and discharging method of one embodiment may further include a step of activating the lithium secondary battery after preparing the lithium secondary battery in the first step and before the second step described below, and this activation step may proceed under a voltage of 4.6V or higher, or under a voltage between 4.6V and 4.9V. As this activation step progresses, the capacity retention rate and life characteristics of the lithium secondary battery can be improved. In one more specific embodiment, the activation may be performed, for example, through a process of charging to a voltage of 4.6V or more at 0.1C at 45° C. and then discharging to 2.0V at 0.1C, but is not limited thereto.

On the other hand, in the lithium-rich manganese-based oxide represented by Formula 1, the ratio of the number of moles of Li to the number of moles of all metal elements excluding Li (Li/Me) may be 1.2 to 1.5, preferably 1.25 to 1.5, and more preferably 1.30 to 1.45. If the Li/Me ratio satisfies the above range, the rate characteristics and capacity characteristics appear excellently. If the Li/Me ratio is too high, electrical conductivity may decrease, the rock-salt phase (Li₂MnO₃) may increase, which may increase the degradation rate. If the Li/Me ratio is too low, the effect of improving energy density is minimal.

On the other hand, the composition of lithium-rich manganese-based oxide may be represented by Formula 2 below.

X Li₂MnO₃·(1-X)Li[Ni_{1-y-z}Mn_{y}M_{z}]O₂ [Formula 2]
wherein in Formula 2,
M is at least one selected from the group consisting of Co, Fe, Cr, V, Cu, Zn, Ti, Al, Mg, B, W, Ga, In, Ru, Nb, Sn, Sr and Zr,
0.2≤X≤0.5, 0.4≤y<1, 0≤z≤0.5.

The X refers to the ratio of Li₂MnO₃ phase (rock-salt phase) in lithium-rich manganese-based oxide, which may be 0.2≤X≤0.5, 0.25≤X≤0.5, or 0.25≤X≤0.4. When the ratio of Li₂MnO₃ phase in lithium-rich manganese-based oxide satisfies the above range, high capacity can be achieved.

The y is the molar ratio of Mn in LiM′O₂ (M′=[Ni_{1-y-z}Mn_{y}M_{z}]; layered phase), which may be 0.4≤y<1, 0.4≤y≤0.8, or 0.4≤y≤0.7.

The z is the molar ratio of the doping element M in LiM′O₂ (M′=[Ni_{1-y-z}Mn_{y}M_{z}]; layered phase), which may be 0≤z≤0.5, 0≤z≤0.3 or 0≤z≤0.1.

On the other hand, the positive electrode active material may further include a coating layer on the surface of the lithium-rich manganese-based oxide, if necessary. If the positive electrode active material includes a coating layer, contact between the lithium-rich manganese-based oxide and the electrolyte is suppressed by the coating layer, which reduces electrolyte side reactions, thereby improving life characteristics.

The coating layer may include a coating element M¹, wherein the coating element M¹ may be, for example, at least one selected from the group consisting of Al, B, Co, W, Mg, V, Ti, Zn, Ga, In, Ru, Nb, Sn, Sr and Zr, preferably, it may be Al, Co, Nb, W, and combinations thereof, and more preferably, it may be Al, Co, and a combination thereof. The coating element M¹ may include two or more kinds, for example, Al and Co.

The coating element may exist in the form of an oxide in the coating layer, that is, M¹Oz (1≤z≤4).

The coating layer may be formed through methods such as dry coating, wet coating, chemical vapor deposition (CVD), physical vapor deposition (PVD), and atomic layer deposition (ALD). Among these, the coating layer is preferably formed by atomic layer deposition, in that the coating layer can be formed with a large area.

The formation area of the coating layer may be 10% to 100%, preferably 30% to 100%, and more preferably 50% to 100%, based on the total surface area of the lithium-rich manganese-based oxide particles. When the formation area of the coating layer satisfies the above range, the effect of improving life characteristics is excellent.

On the other hand, the above-mentioned positive electrode active material may be in the form of secondary particles in which a plurality of primary particles are agglomerated, and the average particle diameter D₅₀ of the secondary particles may be 2 μm to 10 μm, preferably 2 μm to 8 μm, more preferably 4 μm to 8 μm. When the D₅₀ of the positive electrode active material satisfies the above range, the electrode density can be achieved excellently, and deterioration in capacity and rate characteristics can be minimized.

Additionally, the positive electrode active material may have a BET specific surface area of 0.1 m²/g to 10 m²/g, specifically 0.1 m²/g to 5 m²/g, and more specifically 0.1 m²/g to 1 m²/g. If the BET specific surface area of the positive electrode active material is too low, the reaction area with the electrolyte is insufficient, which makes it difficult to achieve sufficient capacity. If the specific surface area is too high, moisture absorption is rapid and side reactions with the electrolyte are accelerated, which makes it difficult to secure life characteristics.

Meanwhile, the lithium-rich manganese-based oxide can be prepared by mixing a transition metal precursor and a lithium raw material and then firing the mixture.

The lithium raw materials may include, for example, lithium-containing carbonate (e.g., lithium carbonate, etc.), hydrate (e.g. lithium hydroxide hydrate (LiOH·H₂O), etc.), hydroxide (e.g. lithium hydroxide, etc.), nitrate (e.g., lithium nitrate (LiNO₃), etc.), chloride (e.g., lithium chloride (LiCl), etc.), and the like. Among these, one kind alone or a mixture of two kinds or more may be used.

Meanwhile, the transition metal precursor may be in the form of a hydroxide, oxide, or carbonate. When a precursor in the form of a carbonate is used, it is more preferable in that a positive electrode active material with a relatively high specific surface area can be prepared.

The transition metal precursor can be prepared through a co-precipitation process. For example, the transition metal precursor may be prepared by a method of dissolving each transition metal-containing raw material in a solvent to prepare a metal solution, mixing the metal solution, an ammonium cation complex former, and a basic compound, and then proceeding with a co-precipitation reaction. Additionally, an oxidizing agent or oxygen gas may be further added during the co-precipitation reaction, if necessary.

At this time, the transition metal-containing raw material may be acetate, carbonate, nitrate, sulfate, halide, sulfide, or the like of each transition metal.

Specifically, the transition metal-containing raw material may be NiO, NiCO₃·2Ni(OH)₂·4H₂O, NiC₂O₂·2H₂O, Ni(NO₃)₂·6H₂O, NiSO₄, NiSO₄·6H₂O, Mn₂O₃, MnO₂, Mn₃O₄ MnCO₃, Mn(NO₃)₂, MnSO₄·H₂O, manganese acetate, manganese halide, Mn₂O₃, MnO₂, Mn₃O₄ MnCO₃, Mn(NO₃)₂, MnSO₄·H₂O, manganese acetate, manganese halide, and the like.

The ammonium cation complex former may be at least one selected from the group consisting of NH₄OH, (NH₄)₂SO₄, NH₄NO₃, NH₄Cl, CH₃COONH₄, and NH₄CO₃.

The basic compound may be at least one selected from the group consisting of NaOH, Na₂CO₃, KOH, and Ca(OH)₂. The form of the precursor may vary depending on the kind of basic compound used. For example, when NaOH is used as a basic compound, a precursor in the form of a hydroxide can be obtained, and when Na₂CO₃ is used as a basic compound, a precursor in the form of a carbonate can be obtained. Additionally, when both a basic compound and an oxidizing agent are used together, a precursor in the form of an oxide can be obtained.

Meanwhile, the transition metal precursor and lithium raw material mixed in an amount such that the molar ratio of total transition metal (Ni+M (Co, etc.)+Mn):Li is 1:1.05 to 1:2, preferably 1:1.1 to 1:1.8, more preferably 1:1.25 to 1:1.8.

Meanwhile, the firing may be performed at a temperature of 600° C. to 1000° C. or 700° C. to 950° C., and the firing time may be 5 hours to 30 hours or 5 hours to hours. Further, the firing atmosphere may be an air atmosphere or an oxygen atmosphere, for example, an atmosphere containing 20 to 100% by volume of oxygen.

The first step can be performed by applying a conventional method for manufacturing a lithium secondary battery in the technical field, except that lithium-rich manganese-based oxide is used as a positive electrode active material. For example, the first step may be performed by interposing a separation membrane or an electrolyte membrane between a positive electrode containing a positive electrode active material and a negative electrode containing a negative electrode active material, sequentially stacking and drying them to produce an electrode assembly, inserting the electrode assembly into a battery case, optionally injecting an electrolyte and sealing the case. The lithium secondary battery may be a cylindrical, prismatic, coin-shaped, or pouch-shaped battery.

The positive electrode and the negative electrode may be manufactured by applying a composition for forming an active material layer containing an electrode active material onto a current collector and then drying it.

The composition for forming the positive electrode active material layer may optionally further include a binder, a conductive material, a filler, and the like, as needed, in addition to the positive electrode active material containing the lithium-rich manganese-based oxide. The composition for forming the negative electrode active material layer may optionally further include a binder, a conductive material, a filler, and the like, as needed, in addition to the negative electrode active material.

The current collector is not particularly limited as long as it has high conductivity without causing a chemical change in the battery, and for example, copper, stainless steel, aluminum, nickel, titanium, calcined carbon, or copper or stainless steel of which surface is treated with carbon, nickel, titanium, silver, or the like, an aluminum-cadmium alloy, or the like may be used. Further, the current collector may generally have a thickness of 3 μm to 500 μm. Also, the current collector may have fine protrusions and depressions formed on a surface thereof to enhance adherence of an active material. For example, the current collector may be used in various forms such as a film, a sheet, a foil, a net, a porous body, a foaming body, and a non-woven fabric structure.

The positive electrode active material may further include a typical positive electrode active material in addition to the lithium-rich manganese-based oxide described above, and for example, it may further include one or more positive electrode active materials selected from the group consisting of LCO(LiCoO₂), LNO(LiNiO₂), LFP(LiFePO₄) and NCM(Li[NiₚCo_{q}Mnᵣ₁]O₂, 0<p<1, 0<q<1, 0<r1<1, p+q+r1=1), but preferably, it may contain at least 70% by weight of lithium-rich manganese-based oxide based on the total weight of the positive electrode active material, and may consist only of the lithium-rich manganese-based oxide.

The positive electrode active material may be included in an amount of 80% to 99% by weight based on the total weight of the positive electrode active material layer.

In one specific embodiment, the negative electrode may include, as a negative electrode active material, any one or more selected from the group consisting of a carbon-based material; a silicone-based material; metals or alloys of lithium and these metals; a metal complex oxide; a material which may be doped and undoped with lithium; a lithium metal; and a transition metal oxide, and preferably, it may include a carbon-based material, a silicon-based material, or a mixture thereof.

As the carbon-based material, any carbon material can be used without particular limitation so long as it is a carbon-based negative electrode active material generally used in a lithium ion secondary battery, and, as a typical example thereof, crystalline carbon, amorphous carbon, or both thereof may be used. Examples of the crystalline carbon may be graphite such as irregular, planar, flaky, spherical, or fibrous natural graphite or artificial graphite, and examples of the amorphous carbon may be soft carbon (low-temperature calcinated carbon) or hard carbon, mesophase pitch carbide, and fired cokes.

The silicon-based material is at least one selected from Si, SiOₓ (0<x<2), and Si—Y alloy (where the Y is an element selected from alkali metals, alkaline earth metals, Group 13 elements, Group 14 elements, transition metals, rare earth elements, and combinations thereof, and is not Si), preferably SiO. The silicon-based negative electrode active material has a capacity that is about 10 times higher than that of graphite, which can reduce the mass loading (mg·cm⁻²) and improve the rapid charging performance of a battery.

As the metals or alloys of lithium and these metals, metals selected from the group consisting of Cu, Ni, Na, K, Rb, Cs, Fr, Be, Mg, Ca, Sr, Si, Sb, Pb, In, Zn, Ba, Ra, Ge, Al and Sn or alloys of lithium and these metals may be used.

As the metal complex oxide, at least one selected from the group consisting of PbO, PbO₂, Pb₂O₃, Pb₃O₄, Sb₂O₃, Sb₂O₄, Sb₂O₅, GeO, GeO₂, Bi₂O₃, B₂O₄, Bi₂O₅, LiₓFe₂O₃(0≤x≤1), LiₓWO₂(0≤x≤1) and SnₓMe₁₋ₓMe′_{y}O_{z} (Me: Mn, Fe, Pb, Ge; Me′: Al, B, P, Si, Groups I, II and Ill elements of the periodic table, halogen; 0<x≤1; 1≤y≤3; 1≤z≤8) can be used.

The material, which may be doped and undoped with lithium, may comprise Sn, SnO₂, Sn—Y (where Y is an element selected from the group consisting of alkali metal, alkaline earth metal, a Group 13 element, a Group 14 element, transition metal, a rare earth element, and a combination thereof, and is not Sn), and a mixture of SiO₂ and at least one thereof may also be used.

In the Si—Y and Sn—Y, the element Y may be selected from the group consisting of Mg, Ca, Sr, Ba, Ra, Sc, Y, Ti, Zr, Hf, Rf, V, Nb, Ta, db(dubnium), Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and a combination thereof.

Examples of the transition metal oxide include lithium-containing titanium complex oxide (LTO), vanadium oxide, lithium vanadium oxide, and the like.

The negative electrode active material may be included in an amount of 80% to 99% by weight based on the total weight of solids in the negative electrode slurry.

The binder is a component that assists in the binding between conductive material, the active material and the current collector, and is usually added in an amount of 0.1 wt. % to 10 wt. % based on a total weight of the active material layer. Examples of the binder include polyvinylidene fluoride (PVDF), polyvinyl alcohol, starch, carboxymethylcellulose (CMC), starch, hydroxypropyl cellulose, regenerated cellulose, polyvinylpyrrolidone, tetrafluoroethylene, polyethylene, polypropylene, ethylene-propylene-diene monomer (EPDM), a sulfonated-EPDM, a styrene-butadiene rubber, a nitrile-butadiene rubber, a fluoro rubber, various copolymers thereof, and the like.

The conductive material is a component that further improves the conductivity of the active material, and may be added in an amount of 10 wt. % or less, preferably 5 wt. % or less based on the total weight of the active material layer. Such a conductive material is not particularly limited as long as it has conductivity without causing a chemical change in the battery, and, for example, graphite such as natural graphite and artificial graphite; carbon black such as acetylene black, Ketjen black, channel black, furnace black, lamp black, or thermal black; conductive fibers such as carbon fibers or metal fibers; fluorinated carbon; metal powder such as aluminum powder, and nickel powder; conductive whiskers such as zinc oxide whiskers and potassium titanate whiskers; conductive metal oxide such as titanium oxide; or polyphenylene derivatives, may be used.

Meanwhile, the lithium secondary battery may be provided by forming an electrolyte layer (or electrolyte-containing layer) between the positive electrode and the negative electrode without a separate separation membrane, but may further include a separation membrane interposed between the positive electrode and the negative electrode. Such a separation membrane is to separate the negative electrode and the positive electrode and to provide a movement path for lithium ions. Any separation membrane may be used without particular limitation as long as it is typically used as a separation membrane in a lithium secondary battery. Particularly, a separation membrane having high moisture-retention ability for an electrolyte as well as low resistance to the movement of electrolyte ions is preferable. Specifically, a porous polymer film, for example, a porous polymer film produced using a polyolefin-based polymer such as an ethylene homopolymer, a propylene homopolymer, an ethylene/butene copolymer, an ethylene/hexene copolymer, and an ethylene/methacrylate copolymer, or a laminated structure having two or more layers thereof may be used. Also, a typical porous non-woven fabric, for example, a non-woven fabric formed of glass fiber having a high melting point, polyethylene terephthalate fiber, or the like may be used. Also, a coated separation membrane including a ceramic component or a polymer material may be used to secure heat resistance or mechanical strength, and may be selectively used in a single-layered or a multi-layered structure.

In addition, the electrolyte may be an organic liquid electrolyte, an inorganic liquid electrolyte, a solid polymer electrolyte, a gel-type polymer electrolyte, a solid inorganic electrolyte, a molten-type inorganic electrolyte, and the like, all of which can be used in the manufacturing of a lithium secondary battery, but is not limited thereto.

In a specific example, the electrolyte may be a liquid electrolyte including an organic solvent and a lithium salt.

Any organic solvent may be used without particular limitation as long as it may serve as a medium through which ions involved in an electrochemical reaction of a battery may move. Specifically, as the organic solvent, an ester-based solvent such as methyl acetate, ethyl acetate, γ-butyrolactone, and ε-caprolactone; an ether-based solvent such as dibutyl ether or tetrahydrofuran; a ketone-based solvent such as cyclohexanone; an aromatic hydrocarbon-based solvent such as benzene and fluorobenzene; a carbonate-based solvent such as dimethyl carbonate (DMC), diethyl carbonate (DEC), methylethyl carbonate (MEC), ethylmethyl carbonate (EMC), ethylene carbonate (EC), and propylene carbonate (PC); an alcohol-based solvent such as ethyl alcohol and isopropyl alcohol; nitriles such as R-CN (where R is a linear, branched, or cyclic C2 to C20 hydrocarbon group and may include a double-bond aromatic ring or ether bond); amides such as dimethylformamide; dioxolanes such as 1,3-dioxolane; or sulfolanes may be used. Among these solvents, a carbonate-based solvent is preferable, and a mixture of a cyclic carbonate (e.g., ethylene carbonate or propylene carbonate) having a high ionic conductivity and a high dielectric constant and a linear carbonate-based compound having a low viscosity (e.g., ethylmethyl carbonate, dimethyl carbonate, or diethyl carbonate), the mixture which may increase charging/discharging performance of a battery, is more preferable.

The lithium salt can be used without particular limitation as long as it may provide lithium ions used in a lithium secondary battery. Specifically, the anion of the lithium salt may be at least one selected from the group consisting of F⁻, Cl⁻, Br⁻, I⁻, NO₃⁻, N(CN)₂⁻, BF₄⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻. The lithium salt may be LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂. LiCl, Lil, LiB(C₂O₄)₂, or the like. The lithium salt may be used in a concentration range of 0.1 M to 2.0 M. When the concentration of the lithium salt is in the above range, the electrolyte has suitable conductivity and viscosity, thereby exhibiting excellent electrolyte performance, and lithium ions can effectively move.

In the electrolyte, in order to improve the life properties of a battery, suppress the decrease in battery capacity, and improve the discharge capacity of the battery, one or more kinds of additives, for example, a halo-alkylene carbonate-based compound such as difluoroethylene carbonate, pyridine, triethylphosphite, triethanolamine, cyclic ether, ethylenediamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride, and the like may be further included. At this time, the additive may be included in an amount of 0.1 to 5 parts by weight based on a total weight of the electrolyte.

Second Step

A method for charging and discharging a lithium secondary battery according to one embodiment includes a second step of charging the lithium secondary battery from the lower limit voltage to the first upper limit voltage and discharging the lithium secondary battery from the first upper limit voltage to the lower limit voltage.

A method for charging and discharging a lithium secondary battery according to one concrete embodiment may include performing the second step 3 to 20 times, specifically 4 to 15 times, and more specifically 5 to 10 times, and then performing the third step.

Further, in the charging and discharging method of one embodiment, the second step and a third step described later performed at a higher voltage are alternately and repeatedly performed on the basis of the fixed number of times of cycles. Specifically, the fixed number of times of cycles includes performing the second step three or more times and performing the third step one or more times. As the fixed number of times of cycles repeatedly progress, charge/discharge of the lithium secondary battery may be performed. In a more specific embodiment, the third step may be performed one or more times for each time the second step is performed 3 to 20 times, specifically 4 to 15 times, and more specifically 5 to times, and the fixed number of times of cycles may be repeated.

In this manner, while driving by the second step, which is a cycle under a relatively low voltage, it is driven by the third step, which is a high voltage cycle in each fixed cycle, and thus, the rock-salt phase (Li₂MnO₃) contained in the positive electrode active material can be further activated. Since additional capacity can be developed, the capacity retention rate and life characteristics of the lithium secondary battery can be greatly improved, and the voltage drop degree during driving can be reduced. Unlike the same, when only driving is performed under a relatively low voltage corresponding to the second step, it is difficult to develop additional capacity, and capacity retention rate and life characteristics may be reduced. On the other hand, even if the second step and the third step proceed together, unless they are repeated alternately at a constant cycle, a problem may occur in which the voltage drop degree during driving becomes large.

On the other hand, in the method for charging and discharging a lithium secondary battery according to a specific embodiment, the second step may be performed a larger number of times than in the third step by 3 to 20 times, specifically 4 to 15 times, more specifically 5 to 10 times, on the basis of the fixed number of times of cycles. It is preferable that the number of times of the second step is three times or more than the number of steps of the third step in that the capacity retention rate can be improved while maintaining the voltage drop during the cycle at a level similar to the existing one. However, if the number of times of the third step is too small, the effect of improving the capacity retention rate is minimal, so it is preferable not to exceed 20 times.

The lower limit voltage may be 2.0V to 3.0V, preferably 2.0V to 2.5V, and more preferably 2.0V. The lower limit voltage is preferably 3.0 V or less to sufficiently develop battery capacity, but is preferably 2.0 V or more in consideration of stable driving of the battery.

The first upper limit voltage may be 4.0V to 4.50V, preferably 4.20V to 4.35V, and more preferably 4.20V to 4.25V. The first upper limit voltage is preferably 4.0V or more in terms of sufficiently developing battery capacity, but considering that the higher the upper limit voltage, the more severe the decomposition of the electrolyte becomes, the upper limit voltage is preferably 4.50 V or less.

The second stage charging may be performed at a rate of 0.05C to 2C, preferably 0.1C to 1C, and more preferably 0.2C to 0.5C. Further, the second stage discharge may be performed at a rate of 0.05C to 3C, preferably 0.1C to 1C, and more preferably 0.2C to 0.5C.

In the second step, charging can be performed using a CC-CV (constant current-constant voltage) method, and discharging can be performed using a CC (constant current) method.

According to one embodiment, the second step may be charging the lithium secondary battery from 2.0V to 4.25V and discharging the lithium secondary battery from 4.25V to 2.0V.

Third Stop

The charging and discharging method of one embodiment includes a third step of charging the lithium secondary battery from the lower limit voltage to the second upper limit voltage and discharging the lithium secondary battery from the second upper limit voltage to the lower limit voltage. The third step may be performed before the second step, but preferably the third step is performed after the second step.

In one specific embodiment, the lower limit voltage of the third step is the same as the lower limit voltage of the second step.

Further, the second upper limit voltage is higher than the first upper limit voltage by 0.05V to 0.20V, preferably 0.05 to 0.15V, and more preferably 0.10V. Specifically, the second upper limit voltage may be 4.05V to 4.70V, preferably 4.25V to 4.50V, and more preferably more than 4.25V and 4.35V or less.

If the difference between the second upper limit voltage and the first upper limit voltage is less than 0.05V, it is not preferable in that the actual difference between the second step and the third step is insignificant, and if the difference is more than 0.20V, the rock-salt phase (Li₂MnO₃) is excessively activated, which may cause a problem that the amount of voltage drop becomes larger than in a conventional charging/discharging method which performs charging and discharging in one voltage range.

Further, the method of charging and discharging the lithium secondary battery involves performing the third step 1 to 3 times, preferably once or twice, and more preferably once, each time the second step is performed 3 to 20 times. It is preferable to perform the third step once rather than performing the step consecutively in that the capacity retention rate can be improved while the voltage drop can be maintained at a level similar to a conventional charging/discharging method which performs charging and discharging in one voltage range.

The charging of the third step may be performed at a rate of 0.05C to 2C, preferably 0.1C to 1C, and more preferably 0.2C to 0.5C. Further, the discharge of the third step may be performed at a rate of 0.05C to 3C, preferably 0.1C to 1C, and more preferably 0.2C to 0.5C.

In the third step, charging can be performed using a CC-CV (constant current-constant voltage) method, and discharging can be performed using a CC (constant current) method.

According to one embodiment, the third step may be charging the lithium secondary battery from 2.0V to 4.35V and discharging the lithium secondary battery from 4.35V to 2.0V.

Hereinafter, preferred embodiments are presented for a better understanding of the invention, but the following examples are for illustrative purposes only, and it will be obvious to those skilled in the art that various variations and modifications can be made without departing from the scope and technical spirit of the invention, and it goes without saying that such variations and modifications fall under the scope of the appended claims.

### Preparation Example

Lithium-rich manganese-based oxide having a composition of Li_{1.16}Ni_{0.305}Co_{0.004}Mn_{0.531}O₂ as a positive electrode active material, carbon black as a conductive material, and polyvinylidene fluoride as a binder were added to N-methyl-2-pyrrolidone (NMP) as a solvent at a weight ratio of 97.74:0.7:1.56 to prepare a positive electrode slurry (solids content of 75.5 wt. %). The positive electrode slurry was applied to a positive electrode current collector (Al thin film) with a thickness of 15 μm, dried and roll-pressed to prepare a positive electrode.

Graphite as a negative electrode active material, SBR-CMC as a binder and carbon black as a conductive material were added to water as a solvent at a weight ratio of 95:3.5:1.5 to prepare a negative electrode slurry (solid content: 60 wt. %). The negative electrode slurry was applied and dried onto a 10 μm thick copper (Cu) thin film, which is a negative electrode current collector, and then roll-pressed to prepare a negative electrode.

Ethylene carbonate (EC):ethylmethyl carbonate (EMC) were mixed at a volume ratio of 30:70, and then LiPF₆ was dissolved to a concentration of 1.0M to prepare an electrolyte solution.

The positive electrode, a polyolefin-based porous separator coated with inorganic particles (Al₂O₃), and the negative electrode were sequentially stacked to prepare an electrode assembly. The assembled electrode assembly was housed in a pouch-type battery case, and the prepared non-aqueous electrolyte solution was injected to prepare a lithium secondary battery.

### EXAMPLE

### Example 1

The lithium secondary battery prepared in the Preparation Example was connected to a PNE charger/discharger, charged to SOC 100% (4.6V) for about hours at 45° C. and 0.1C rate, and then discharged to SOC 0% (2.0V) for about hours at 45° C. and 0.1C rate to perform activation (formation). Aging was then performed at 60° C. for 15 hours, and then a degas process was performed.

For the lithium secondary battery whose degassing was completed, the process of charging and discharging 9 times under the first charging/discharging conditions below and then charge and discharge once under the second charging/discharging conditions below was repeated 10 times, for a total of 100 charge and discharge cycles.
First charge/discharge: charged under CC-CV (constant current-constant voltage) conditions up to 4.25V at a rate of 0.33C at 45° C., and discharged under CC conditions up to 2.0V at a rate of 0.33C.
Second charge/discharge: charged under CC-CV conditions up to 4.35V at 45° C. at a rate of 0.33C, and discharged under CC conditions up to 2.0V at a rate of 0.33C.

### Comparative Example 1

A lithium secondary battery was charged and discharged in the same manner as in Example 1, except that charging and discharging were performed 100 times only under the first charging/discharging condition.

### Comparative Example 2

A lithium secondary battery was charged and discharged in the same manner as in Example 1, except that charging and discharging was performed 100 times only under the second charging/discharging condition.

### Experimental Example: Measurement of Energy Retention Rate and Voltage Drop

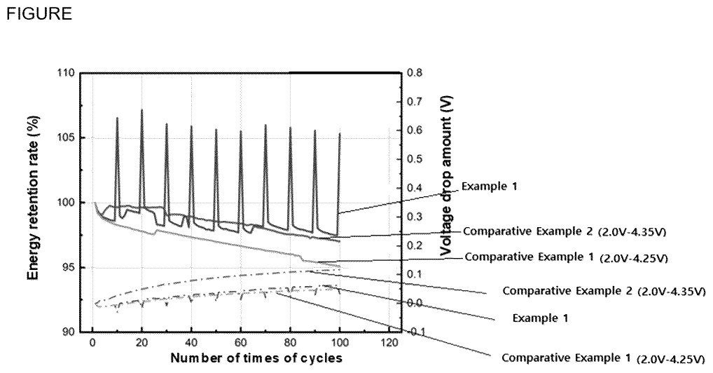

While performing charging and discharging as in Examples and Comparative Examples, the energy retention rate and the amount of voltage drop were measured through the process of measuring the discharge energy and discharge average voltage value corresponding to each cycle. That is, the amount of voltage drop in FIG. 1 is a value indicating how much the voltage has decreased in the average discharge voltage of the corresponding cycle.

Through FIG. 1, it was confirmed that in the charging and discharging of Example 1, the degree of voltage drop was similar to the charging and discharging of Comparative Example 1 where the upper limit voltage was set to 4.25V, and the energy retention rate was measured to be much higher. In addition, when compared with the charging and discharging of Comparative Example 2 where the upper limit voltage was set to 4.35V, it can be confirmed that the degree of voltage drop was much improved, but the energy retention rate exhibited the same level.

Additionally, when charging and discharging under the first charging/discharging conditions and the second charging/discharging conditions are repeated alternately at a constant cycle as in Example 1, it is expected that the degree of voltage drop will be improved compared to the case where charging and discharging under the second charging/discharging conditions is performed all at once after charging and discharging under the first charging/discharging conditions.

1. A method for charging and discharging a lithium secondary battery, comprising:
a first step of preparing a lithium secondary battery including a positive electrode, a negative electrode and an electrolyte, with the positive electrode comprising lithium-rich manganese-based oxide having a manganese content of 50 mol % or more among all metals excluding lithium as a positive electrode active material;
a second step of charging the lithium secondary battery from a lower limit voltage to a first upper limit voltage and discharging the lithium secondary battery from the first upper limit voltage to the lower limit voltage; and
a third step of charging the lithium secondary battery from the lower limit voltage to a second upper limit voltage and discharging the lithium secondary battery from the second upper limit voltage to the lower limit voltage,
wherein the second upper limit voltage is 0.05V to 0.20V higher than the first upper limit voltage, and the second step and the third step are alternately and repeatedly performed on the basis of a fixed number of times of cycles.

2. The method according to claim 1, wherein:
the lithium-rich manganese-based oxide is represented by Formula 1 below:
Liₐ[Mn_{1-b-c}Ni_{b}M_{c}]₂₋ₐO₂ [Formula 1]
wherein in Formula 1,
M is at least one selected from the group consisting of Co, Fe, Cr, V, Cu, Zn, Ti, Al, Mg, B, W, Ga, In, Ru, Nb, Sn, Sr and Zr,
a, b and c are the atomic fractions of independent elements, wherein 1<a, 0≤b≤0.5, 0≤c≤0.5, 0<b+c≤0.5.

3. The method according to claim 1, wherein:
the fixed number of times of cycles comprises
performing the second step three or more times and
performing the third step one or more times, and
the fixed number of times of cycles are repeatedly performed.

4. The method according to claim 1, wherein:
after performing the second step three to twenty times, the third step is performed.

5. The method according to claim 1, wherein:
after performing the second step, the third step is performed once to three times.

6. The method according to claim 1, wherein:
the second step is performed a larger number of times than in the third step by three to twenty times.

7. The method according to claim 1, wherein:
the first upper limit voltage is from 4.0V to 4.50V.

8. The method according to claim 1, wherein:
the second upper limit voltage is from 4.05V to 4.70V.

9. The method according to claim 1, wherein:
the lower limit voltage is from 2.0V to 3.0V.

10. The method according to claim 1, wherein:
the second step is performed after activation of the lithium secondary battery prepared in the first step.

11. The method according to claim 10, wherein:
the activation proceeds under a voltage of 4.6V or more.

12. The method according to claim 1, wherein:
the negative electrode comprises a carbon-based material, a silicon-based material, or a mixture thereof as a negative electrode active material.

13. The method according to claim 1, wherein:
the lithium secondary battery further comprises a separator interposed between the positive electrode and the negative electrode.
